(19) United States
(12) Patent Application Publication
(10) Pub. No.: US 2015/0125551 A1
(43) Pub. Date: May 7, 2015

(54) METHOD AND APPARATUS FOR MAKING STABLE ACIDIC CHLORINATED SOLUTIONS

(71) Applicant: Global Chemical Technologies Limited, Daventry (GB)

(72) Inventors: Stephen Thomas BOND, Daventry (GB); Kevin John BYRNE, Drointon (GB); Simon Joseph WARD, Crick (GB); Natasha Ann Crawford PAGE, Broughton (GB)

(21) Appl. No.: 14/518,598

(22) Filed: Oct. 20, 2014

(30) Foreign Application Priority Data
Oct. 25, 2013 (GB) 1318907.1

(51) Int. Cl. A01N 59/08; C02F 1/50; C02F 1/30; A01N 59/00

(52) U.S. Cl. CPC A01N 59/08; A01N 59/00; C02F 1/50; C02F 1/30
USPC 424/665; 424/661; 210/756; 210/748.16

(57) ABSTRACT

A method of manufacturing and an apparatus for making an aqueous chlorine solution having a pH between 3.0 and 6.5 and a stability such that after 6 weeks storage at 20 degrees Celsius the pH remains in the range 3.0 to 6.5 and the amount of chlorine lost from the solution is less than 10%, such that the method includes:

(a) Providing a source of water having an electrical conductivity at 20 degrees Celsius of no more than 50 (and preferably no more than 4.3) μScm-¹
(b) Reacting the water with solid calcium hypochlorite having a purity of at least 60%; and
(c) Adjusting the pH to between 3.0 and 6.5.

### FIELD OF THE INVENTION

The present invention concerns a method of producing solutions for use in disinfection and in the chlorination of water. The invention also concerns an apparatus for the manufacture of solutions for use in disinfection and in the production of chlorinated water.

### BACKGROUND OF THE INVENTION

Unclean water is responsible for a significant amount of death and illness, particularly in developing countries. Access to clean water for drinking and other uses is therefore vitally important. Adding chlorine to water is a well-established method of treating water. It is thought that microbial cells are killed by both Cl₂ and HOCl (hypochlorous acid) which is the hydrolysis product produced when Cl₂ is dissolved in water. For that reason hypochlorous acid may sometimes be referred to as “chlorinated water”.

Various methods have been used to chlorinate water including the desolution of gaseous Cl₂ and the addition of a salt of hypochlorous acid such as sodium hypochlorite or calcium hypochlorite. Hypochlorite solutions are also useful as disinfection agents and as bleaches with a variety of domestic, industrial and medical uses.

Solutions of sodium hypochlorite are manufactured cheaply and in vast quantities by the chloralkali process which involves the electrolysis of brine (sodium chloride solution).

Hypochlorous acid solutions produced by electrolytic processes suffer from a significant drawback because they contain a high level of chloride ions as an impurity. That impurity results in poor storage stability and pH fluctuations with time. The problem of poor storage stability is solved by either producing the hypochlorous acid on site for immediate or by producing an alkali solution which has acceptable stability even in the presence of chloride ions.

Alkali solutions of hypochlorite are not as effective as disinfectants as more neutral or acidic solutions. In some applications (for example domestic bleach solutions sold for cleaning toilets) this may not matter very much because the low cost of the product means that it is practical to simply use a greater volume and/or greater concentration of the product to obtain the same disinfection as would be provided by a smaller amount of a less alkali solution. When used to chlorinate drinking water the lower efficacy of alkali solutions may result in more chlorine-based species being added to the water than would otherwise be necessary to obtain adequate disinfection. This goes against efforts to minimise chlorination levels in drinking water because of health and consumer-acceptability concerns.

There is a demand for acidic aqueous chlorinated solutions but producing them has proved problematic because of safety, odour and stability concerns.

WO2012/123695 discloses a method of manufacturing moderately-stable acidic solutions of hypochlorous acid in relatively small quantities.

The data presented therein shows that the product starts degrading from day 7 and has lost 20% of its Cl₂ content by day 28 after manufacture. It does not disclose that stability may be extended beyond that time.

The present invention is based on the identification of routes of chloride-mediated instability and their elimination or minimisation and results in a product with greater stability than that disclosed in WO2012/123695 which may be manufactured by a fully integrated process.

### SUMMARY OF THE INVENTION

The first aspect of the invention provides a method of manufacturing an aqueous solution of chlorine having a pH between 3.0 and 6.5 and a stability such that after 6 weeks storage at 20 degrees Celsius the pH remains in the range 3.0 to 6.5 and the amount of chlorine lost from the solution is less than 10%, the method comprising:
a) Providing a source of water having an electrical conductivity of no more than 50 μScm⁻¹ at 20° C.
b) Reacting said water with solid calcium hypochlorite having a purity of at least 60%; and
c) Adjusting the pH to between 3.0 and 6.5.

The methods of the invention are developments of methods disclosed in WO 2012/123695.

However, the resulting solution has a greater stability than reported in WO 2012/123695 as a result of the combination of at least some, and preferably all, of the following features:

1, Water Source.

Prior art methods specify “de-ionised water” as a starting material. It is possible for such water to be of use if the chloride content of other components is low. Therefore, the methods of the present invention use water which has an electrical conductivity of no more than 40 μScm⁻¹ at 20° C., optionally no more than 30 μScm⁻¹ at 20° C., optionally no more than 20 μScm⁻¹ at 20° C. and optionally no more than 10 μScm⁻¹ at 20° C. The preferred aspects of the present invention are based on the realisation that even water sold as “de-ionised” and even water meeting purity standards such as those specified in various pharmacopeia can still contain enough chloride ions to be detrimental to the stability of the final product. Accordingly, it is preferred that the methods of the present invention use water which is ultra pure as determined by the water having an electrical conductivity of no more than 4.3 μScm⁻¹ at 20° C., optionally no more than 3.5 μScm⁻¹ at 20° C., optionally no more than 3 μScm⁻¹ at 20° C., optionally no more than 2.5 μScm⁻¹ at 20° C., optionally no more than 2.1 μScm⁻¹ at 20° C., and optionally no more than 1.9 μScm⁻¹ at 20° C. If the electrical conductivity of the water is no more than 4.3 μScm⁻¹ at 20° C., a stability may be attained such that after three months and optionally after 6 months storage at 20 degrees Celsius the pH remains in the range 3.0 to 6.5 and the amount of chlorine lost from the solution is less than 10%. Preferably methods of the invention comprise continuous monitoring of water conductivity to ensure that it stays below one of these conductivity thresholds constantly.

2, on-Site Water Production.

It has been discovered that the conductivity of water may rise during transport and storage for example due to entry of atmospheric gases or due to microbial activity and that these rises may be sufficient to have a negative impact on the stability of the final product. Therefore according to methods of the present invention, the water used not only meets the purity requires specified in paragraph 1 above, but it is purified on site so that it can be piped into subsequent steps. Any fresh water source may be used as a starting material. That water is optionally subjected to an ion-exchange process to remove any hard water ions which might result in scale build-up on plant. The water is then purified to meet the stringent conductivity requirements specified by the present invention. Preferably the water is purified in a process comprising at least two stages, the first stage being a reverse osmosis process and the second stage being a “polishing” process using a mixed bed ion exchange resin wherein residual ions (such as chloride ions) are exchanged for H⁺ and OH⁻ ions. On-site water production does not preclude storage or low conductivity water adjacent to where it is to be used, but if such storage is needed, steps should be taken to prevent contamination during storage.

3, Storage of Low Conductivity Water.

Water meeting the requirements specified in paragraph 1 above and having been produced by a method specified in paragraph 2 above may be used immediately in subsequent steps of the method. If it needs to be stored great care should be taken to prevent it from becoming contaminated. It may optionally be stored in a sealed tank. If the tank is in communication with the atmosphere this is preferably via a vent which prevents contamination, for example a vent having a 0.2 micron filter. Preferably the conductivity of the stored water is measured again before use in subsequent steps and only used if it is found to comply with the stringent requirements set out in paragraph 1 above.

The water storage container may have a volume of at least 1000 litres, optionally at least 2000 litres, optionally at least 3000 litres and optionally at least 4000 litres. The method may comprise admitting air into the water storage container. The method may comprise filtering said air. The temperature of the stored water may be less than 25° C., optionally less than 23° C. and optionally about 20° C. Maintaining the temperature of the stored water at a relatively low level further inhibits the growth of microbes in the water.

The method may comprise removing water from the water container and reintroducing at least some of the removed water into the water container. This may help reduce microbial growth by providing a flow or movement of water, inhibiting water stagnation. Reintroduction of at least some of the removed water into the water container may comprise generating a spray of water. The rate of reintroducing removed water into the water storage container may by at least 1000 l/hr, optionally at least 2000 l/hr, optionally at least 3000 l/hr and optionally at least 5000 l/hr.

The method may comprise treating at least some of the water removed from the water container to kill microbes therein, and optionally reintroducing at least some of the treated water into the water storage container. Treating the water to kill microbes may comprise exposing the water to antimicrobial electromagnetic radiation, such as ultra-violet (UV) radiation.

The method may comprise filtering at least some of the water removed from the water storage container and optionally reintroducing at least some of the filtered water into the water storage container. Filtering the water may comprise passing the water through a filter, such as a 1 micron filter.

The method may comprise cooling at least some of the water removed from the water storage container and optionally reintroducing at least some of the cooled water into the water storage container.

4, Source of Calcium Hypochlorite.

The solid calcium hypochlorite is at least 60% pure (by weight), preferably at least 70% or 72% or 75% or 80% pure. The level of chloride contamination in the calcium hypochlorite must be as low as possible and in all cases below 3.0 wt % chloride, more preferably below 2.0 wt % chloride, more preferably below 1.0 wt % chloride.

5, Reaction Step.

Mixing the water with the calcium hypochlorite and the pH controlling agent may take place in one or more reaction vessels. Optionally at least one and optionally each reaction vessel has a volume of at least 10001, optionally at least 20001 and optionally about 30001. The method may comprise mixing the water with calcium hypochlorite and the pH controlling agent in a first reaction vessel and in a second reaction vessel. The provision of two reaction vessels facilitates the delivery of chlorine solution from one reaction vessel while a chlorine solution is being prepared in another reaction vessel. Furthermore, the use of two or more reaction vessels facilitates the making of solution of mutually different chlorine concentrations. The method therefore may comprise preparing a chlorine solution having a first chlorine concentration in a first reaction vessel and preparing a chlorine solution having a second chlorine concentration in a second reaction vessel.

The method may comprise sensing the pH of the chlorine solution and adding a pH controlling agent dependent on the sensed pH. The method may also comprise sensing the chlorine content of the chlorine solution.

The mixing of the water with the calcium hypochlorite and the pH controlling agent may generate one or more precipitates. The method may therefore comprise removing one or more precipitates, for example, by settling or filtration. For example if the pH controlling agent is phosphoric acid a calcium phosphate precipitate may be produced. The method may comprise providing one or more filters for removing precipitate from the hypochlorous acid solution.

6, pH Controlling Agent.

This will typically be an acid. WO 2012/123695 suggests that it might be hydrochloric acid. However, hydrochloric acid should not be used because it is a source of chloride ions which will negatively impact the stability of the final product. The pH controlling agent is preferably phosphoric acid because calcium phosphate is insoluble and may therefore be easily removed, for example by means of settlement or filtration, and sold as a useful plant nutrient product.

The method of the present invention is suitable for providing large volumes of product for example at a rate of at least 5001/hour.

The method of the present invention generates an acidic solution comprising chlorine. It is beneficial that the mixing of water with the calcium hypochlorite takes place in a chlorine-resistant environment. It is therefore preferred that the one or more reaction vessels comprise chlorine-resistant reaction-mixture contacting surfaces. Such surfaces may be provided by providing a coating of chlorine-resistant material or by provided a reaction vessel shaped from chlorine-resistant material. Examples of such chlorine-resistant materials include polyvinyl chloride, polyvinylidene fluoride and polyethylene terephthalate.

Likewise, it is preferred that any surface which contacts chlorine comprises chlorine-resistant material. It is also preferred that any surface which comes into contact with the precursors or product of the method are inert to the extent that they do not leach ions or other contaminants which have a negative influence on stability.

For the avoidance of doubt, it should be noted that, and it is well known that, the aqueous chlorine solution comprises several species in equilibrium. As illustrated below, chlorine dissolves in water to produce hypochlorous acid, hydrogen ions and chloride ions. The hypochlorous acid dissociates to produce hydrogen ions and hypochlorite ions.

Cl₂+H₂O [symbol] HOCl+H⁺+Cl⁻

HOCl [symbol] H⁺+OCl⁻

According to a second aspect of the invention there is provided an aqueous chlorine solution having a pH between 3.0 and 6.5 and a stability such that after 6 weeks storage at 20° C. the pH remains in the range 3.0 to 6.5 and the amount of chlorine lost from the solution is less than 10%. Preferably, the chlorine solution has a stability such that after 3 months and optionally after 6 months storage at 20° C. the pH remains in the range 3.0 to 6.5 and the amount of chlorine lost from the solution is less than 10%. More preferably the pH is between 3.5 and 6, 4 and 6 or 4.5 and 6. More preferably the amount of chlorine lost from the solution after storage at 20° C. for 6 months is less the 9%, less than 8%, less than 7%, less than 6%, less than 5%, less than 4%, less than 3% or less than 2%.

The aqueous chlorine solution may have a chlorine content of at least 100 ppm, optionally at least 500 ppm, optionally at least 800 ppm, optionally at least 1000 ppm, optionally at least 3000 ppm and optionally at least 5000 ppm.

The aqueous chlorine solution may have a chlorine content of up to 8,000 ppm and optionally up to 10,000 ppm.

The aqueous chlorine solution therefore optionally has a chlorine content of from 100 to 10,000 ppm.

The aqueous chlorine solution may comprise 100-1000 ppm calcium, optionally 100-800 ppm calcium.

The ratio of chlorine:chloride should not exceed 10:1.

The aqueous chlorine solution may have an oxidation-reduction potential of at least 500 mV, optionally at least 600 mV, optionally at least 700 mV, optionally at least 800 mV, optionally at least 900 mV and optionally at least 1V.

The aqueous chlorine solution may be relatively stable in that it retains one or more of its key disinfecting characteristics over a long period of time. For example, the chlorine content of the aqueous solution after six months may be at least 90% (and optionally at least 93% and optionally at least 95%) of the initial chlorine content of the solution. The pH of the aqueous solution after six months may be within 2 (and optionally within 1.5 and further optionally within 1) of the initial pH of the aqueous solution. The oxidation-reduction potential of the aqueous solution after six months may have an oxidation-reduction potential of at least 500 mV, optionally at least 600 mV, optionally at least 700 mV, optionally at least 800 mV, optionally at least 900 mV and optionally at least 1V. The pH of the aqueous solution is optionally from 3.0 to 6.5 after six months storage.

In accordance with a third aspect of the present invention, there is provided an apparatus for the production of an aqueous chlorine solution, the apparatus comprising:

An apparatus for providing water having an electrical conductivity of 4.3 μScm-¹ or less at 20° C., one or more reaction vessels for the production of an acidic aqueous chlorine solution being adapted to receive water from the apparatus for providing water and having at least one inlet for the introduction there through of solid calcium hypochlorite and a pH controlling agent,

one or more outlets for receiving the aqueous chlorine solution from the one or more reaction vessels and for delivering aqueous chlorine solution to a receptacle.

The apparatus facilitates the manufacture of an acidic aqueous chlorine solution on a large scale.

Those skilled in the art will realise that the receptacle is not part of the apparatus of the present invention.

The apparatus for providing water comprises a conductivity reduction system adapted to deliver water having a reduced electrical conductivity to the water storage container or directly to the one or more reaction vessels. It is desirable for the electrical conductivity of the water to be low (such as no more than 4.3 μScm⁻¹, 3.5 μScm⁻¹, 3.2 μScm⁻¹, 3 μScm⁻¹, 2.5 μScm⁻¹, 2.1 μScm⁻¹, and 1.9 μScm⁻¹ μScm⁻¹ at 20° C.), since ionic impurities (in particular, chloride) affect the shelf life of the solution. The conductivity reduction system optionally comprises one or more of a reverse osmosis unit, a mixed bed ion exchange unit and a still for distilling water. The apparatus may comprise a water softener for reducing the magnesium and/or calcium content of water. The water softener is optionally upstream of, and in fluid communication with, the conductivity reduction system.

The apparatus for providing water may further comprise a water storage container arranged to be filled by water exiting the conductivity reduction system.

The water storage container may have a volume of at least 20001, optionally at least 30001 and optionally at least 50001.

The water storage container is optionally provided with a vent to permit ingress of air into the water storage container. The vent may be provided with a filter to inhibit ingress of particulate into the water storage container.

The water storage container is optionally provided with a spray generator for generating a spray of water. The spray generator maintains circulation of water within the headspace of the tank which helps inhibit the proliferation of certain microbes in the water.

The apparatus optionally comprises a return line adapted to reintroduce water into the water storage container.

The return line is optionally connected to a spray generator (if present) so that water passing through the recycle line is reintroduced into the water storage container via the spray generator.

The apparatus is optionally provided with a cooler. The cooler may be adapted to cool water in a cooling conduit. This has been found to be an effective way of cooling water so that its temperature is less favourable for the growth of microbes. The cooling conduit may be arranged to deliver cooled water to the return line (if present).

The apparatus may be provided with a source of electromagnetic radiation (typically ultra violet radiation) for killing microbes in the water. The source of electromagnetic radiation may be arranged to irradiate water in a flow path between the water storage container and the one or more reaction vessels.

The apparatus may comprise a plurality of reaction vessels. As discussed above in relation to the method of the first aspect of the present invention, there are benefits in using more than one reaction vessel. At least one (optionally more than one and optionally each) reaction vessel may have a volume of at least 10001, optionally at least 20001 and optionally about 30001.

One or more filters may be provided in a flow path between the water storage container and the one or more reaction vessels. Such filters may be selected to remove microbes from the water.

The apparatus may comprise one or more electrical conductivity sensors for sensing the electrical conductivity of the water. Optionally, an electrical conductivity sensor may be provided upstream of the water storage container (optionally downstream of the conductivity reduction system, if present).

The apparatus may comprise a load cell for weighing the aqueous solution of hypochlorous acid.

The apparatus may comprise one or more filters for filtering the chlorinated water produced in the one or more reaction vessels. The filter would typically remove precipitates, such as calcium phosphate.

It is therefore preferred that the one or more reaction vessels comprise chlorine-resistant reaction-mixture contacting surfaces. Such surfaces may be provided by providing a coating of chlorine-resistant material or by provided a reaction vessel shaped and/or constructed from chlorine-resistant material. Examples of such chlorine-resistant materials include polyvinyl chloride, polyvinylidene fluoride and polyethylene terephthalate.

Likewise, it is preferred that any surface which contacts chlorine comprises chlorine-resistant material. For example, any conduits providing a flow path from the one or more reaction vessels to the outlet optionally comprise liquid-contacting surfaces which are chlorine-resistant.

In accordance with a fourth aspect of the present invention, there is provided a facility for the production of an acidic aqueous chlorine solution comprising an apparatus in accordance with the third aspect of the present invention located within a shipping container.

The shipping container is otherwise known as an “ISO container”, and typically has a generally cuboid shape.

The water processing facility of the fourth aspect of the invention typically comprises a conductivity reduction system operable to reduce the electrical conductivity of water. The conductivity reduction system is typically located in a first region of the shipping container. The one or more reaction vessels are typically located in a second region of the shipping container, the second region of the shipping container being separated from the first region of the shipping container.

It will of course be appreciated that features described in relation to one aspect of the present invention may be incorporated into other aspects of the present invention. For example, the method of the first aspect of the present invention may incorporate any of the features described with reference to the apparatus of the third aspect of the present invention and vice versa.

Providing the apparatus for carrying out the methods of the invention in a shipping container provides a number of advantages including ease of transport to where it is needed. This may provide environmental benefits because by bringing production of solutions of the invention close to where the solution is to be used, the distance over which the solution will need to be transported is reduced with obvious saving in carbon emissions and congestion. It also means that if a production site is no longer needed it can be easily transported elsewhere and reused rather than being scrapped.

### DESCRIPTION OF THE DRAWINGS

Embodiments of the present invention will now be described by way of example only with reference to the accompanying schematic drawings of which:

FIG. 1 shows a schematic flow diagram of a processing plant according to a first embodiment of the invention;

FIG. 2 shows a schematic side-on view of a processing plant according to a first embodiment of the invention; and

FIG. 3 shows a plan view of the processing plant of FIG. 2.

### DETAILED DESCRIPTION

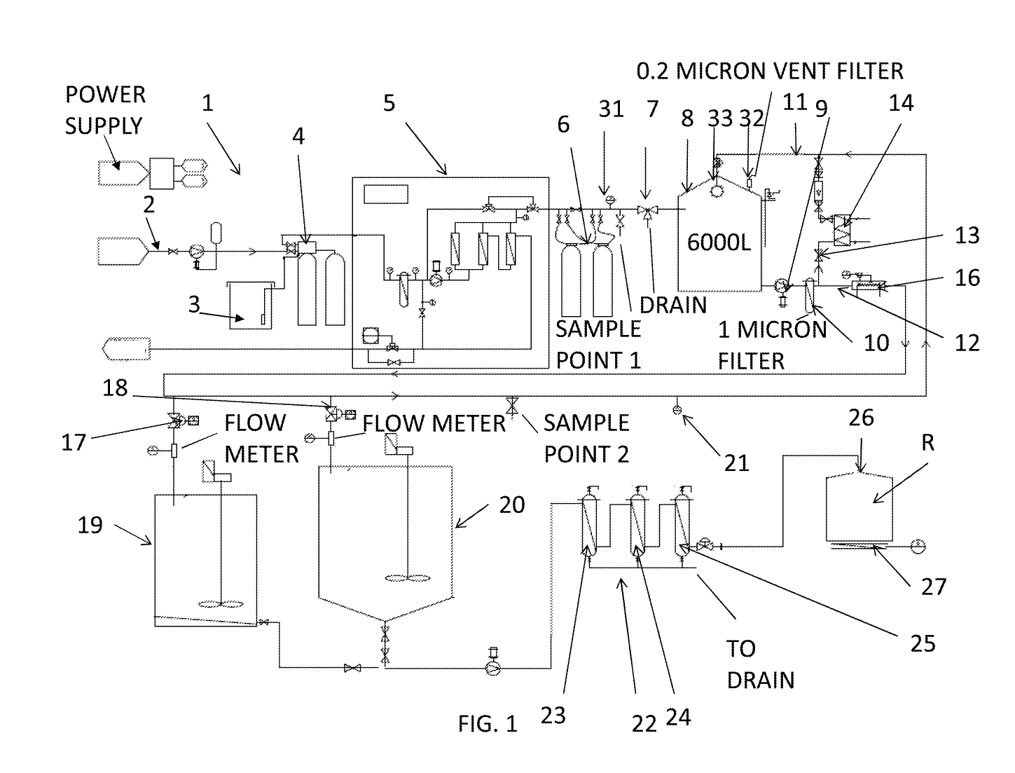

Apparatus according to the invention will now be described with reference to FIG. 1. The apparatus is denoted generally by reference numeral 1 and comprises a water storage container 8 for the storage of water having an electrical conductivity of no more than 4.3 μScm⁻¹ at 20° C. in fluid communication with two reaction vessels 19, 20 in which the water is treated with a source of chlorine (typically calcium hypochlorite) and a pH controlling agent (typically an acid, such as phosphoric acid) to produce chlorinated water which has a pH of from about 3 to about 6.5 and a chlorine content of from 100 to 10,000 ppm. The apparatus 1 will now be described in more detail. The apparatus 1 uses mains water and therefore comprises an inlet 2 for introduction of water into the apparatus. The inlet 2 is operable to deliver up to 3000 l/h water to the apparatus 1. This mains water has a relatively high electrical conductivity (up to 2500 μScm⁻¹ in the UK), and may have a relatively high chloride content. This is undesirable. Therefore, the apparatus 1 is provided with a reverse osmosis unit denoted generally by reference numeral 5. Reverse osmosis involves the passage of water through one or more membranes and the presence of particulate or precipitate in the water is undesirable because the membranes can become blocked. The risk of membrane blockage may be reduced by softening the water using a water softener 4 which is supplied by a brine tank 3. Those skilled in the art will realise that the water softener 4 reduces the concentration of ions which form scale, such as calcium and magnesium ions. Water which has been treated by the water softener 4 and the reverse osmosis unit 5 is then passed through a mixed bed ion exchange system 6 which is used to remove ions from the water, replacing cations with hydrogen ions and anions with hydroxide ions. The electrical conductivity of the water is measured using conductivity sensor 31 located immediately downstream of the mixed bed ion exchange system 6. In the event that the electrical conductivity of the water is found to be above a certain level (typically 4.3 μScm⁻¹ at 20° C.) an alarm (not shown) may be sounded. Furthermore, valve 7 located immediately downstream of the conductivity sensor 31 and immediately upstream of the water storage container 8 may be operable to slow or prevent flow to the water storage container 8 in the event that the water conductivity is found to be too high.

The water storage container 8 is made from polypropylene and is provided with an outlet 9. Water leaving the water storage container 8 is filtered by 1 micron filter 10 to remove microbes from the water. Some of the water is then directed into cooling branch 13 and some of the water is directed to reactor supply branch 12.

A heat exchanger 14 cools the water passing through the cooling branch 13, this cooled water then being passed into return line 11 for reintroduction into the water storage container 8 via spray head 33. The spray generated by the spray head 33 helps inhibits the growth of certain microbes. Cooling of water in cooling branch 13 reduces the temperature of the water in the water storage container to about 20° C. This helps limit microbe growth in the water. The water storage container 8 is provided with a vent 32 for equalising the pressure in the storage container 8. The vent is provided with a 0.2 micron filter (not shown) which inhibits the ingress of microbes into the water storage container 8. The water storage container 8 has a volume of about 60001.

Water passing through reactor supply branch 12 is irradiated by a source of ultraviolet radiation 16 to kill microbes in the water. Valves 17, 18 are used to control the flow of water from reactor supply branch 12 to reactor vessels 19, 20. Much of the water passing through reactor supply branch 12 will be reintroduced into the water storage container 8 via return line 11 and the spray head 33. The electrical conductivity of the water passing through reactor supply branch 12 is monitored by an electrical conductivity sensor 21. In the event that the electrical conductivity of the water is found to be above a certain level (typically 4.3 μScm⁻¹) an alarm (not shown) may be sounded. Furthermore, valves 17, 18 may be operable in the event that the water conductivity is found to be too high. The passage of the water through the filter 10 and the use of the UV source 16 helps maintain the level of microbes in the water to within European Pharmacopeia limits.

The operation of reactor vessels 19, 20 will now be described. Reactor vessels 19, 20 each have a volume of about 30001. When sufficient water has been introduced into one or both of the reactor vessels 19, 20, solid calcium hypochlorite (typically 78% calcium hypochlorite having a low chlorate and chloride content, such as HTH® Shock from Arch Chemicals Ltd., Castleford, West Yorkshire, UK) is added to the water and stirred. Phosphoric acid (typically food grade phosphoric acid, for example, from Univar, Cheshire, UK) is then added, and the pH of the reaction mixture is monitored. Generally, sufficient phosphoric acid is added to generate a precipitate of calcium phosphate. Acidification leads to the generation of hypochlorous acid and a low pH. The use of phosphoric acid is beneficial because the chloride content of phosphoric acid is low, this being desirable because the presence of chloride ions can lead to the resultant solution having a low shelf life. The reaction vessels are made from polypropylene which is chlorine-resistant. Furthermore, the stainless steel mixer shaft and propeller (not labelled) are coated with polyvinylidene fluoride (PVDF). PVDF is a chlorine-resistant material which is used to coat stainless steel which may otherwise leach metal ions into solution which may catalyse the unwanted breakdown of chlorine species which could reduce the shelf-life of the chlorine solution.

The acidified chlorine solution is then passed from the reactor vessels 19, 20 to outlet 26 via a filtration system 22 comprising three 1 micron filters 23, 24, 25. The filters help remove precipitate, such as calcium phosphate. The acidified chlorine solution is dispensed into receptacle R located on load cell 27.

The internal surfaces of the reactor vessels 19, 20 and the conduits (not labelled) for delivering acidified chlorine solution from the reactor vessels 19, 20 to the outlet 26 comprise chlorine-resistant materials. This reduces the level of metal ions in the solution which would otherwise catalyse the breakdown of chlorine species, which is detrimental to the shelf-life of the acidified chlorine solution. In this connection, all of the pipework and conduits are made from medium-density polyethylene or polyvinyl chloride. The materials of construction also have a low organic load to further reduce any halogen loss.

### Examples 1 to 3

The apparatus and method described above in relation to FIG. 1 have been used to make acidified chlorine solutions having an improved shelf-life. Solutions having different initial chlorine concentrations were made. The chlorine concentration, pH and the oxidation-reduction potential were measured over time. The water used to make the acidic chlorine solutions in Examples 1 to 3 had an electrical conductivity of about 1.8 μScm⁻¹ at 20° C.

### Example 1

TABLE 1

| | Time (months) | | | | | | |
|---|---|---|---|---|---|---|---|
| | 0 | 1 | 2 | 3 | 4 | 5 | 6 |
| Cl₂ concentration | 4350 | 4200 | 4150 | 4300 | 4250 | 4150 | 4150 |
| (ppm) | | | | | | | |
| pH | 3.95 | 3.3 | 3.21 | 3.3 | 3.15 | 3.28 | 3.11 |
| Oxidation- | | >1000 | | >1000 | | >1000 | 1202 |
| reduction | | | | | | | |
| potential (mV) | | | | | | | |

### Example 2

TABLE 2

| | Time (months) | | | | | | |
|---|---|---|---|---|---|---|---|
| | 0 | 1 | 2 | 3 | 4 | 5 | 6 |
| Cl₂ concentration | 2350 | 2300 | 2050 | 2275 | 2250 | 2275 | 2250 |
| (ppm) | | | | | | | |
| pH | 4.41 | 3.67 | 3.72 | 3.5 | 3.55 | 3.32 | 3.83 |
| Oxidation- | | | >1000 | | >1000 | 1181 | 1158 |
| reduction | | | | | | | |
| potential (mV) | | | | | | | |

### Example 3

TABLE 3

| | Time (months) | | | | | | |
|---|---|---|---|---|---|---|---|
| | 0 | 1 | 2 | 3 | 4 | 5 | 6 |
| Cl₂ concentration | 1160 | 1060 | 1100 | 1000 | 1090 | 1150 | 1110 |
| (ppm) | | | | | | | |
| pH | 5.13 | 4.59 | 4.19 | 4.24 | 4 | 4.5 | 3.76 |
| Oxidation- | | >1000 | | >1000 | | >1000 | 1142 |
| reduction | | | | | | | |
| potential (mV) | | | | | | | |

The data above demonstrate that the method and apparatus of the present invention are effective at making acidified chlorine solutions that have a relatively stable pH, maintain high levels of chlorine and a high oxidation-reduction potential over a long period of time.

### Example 4

An embodiment of an acidic chlorine solution in accordance with the present invention was made by mixing low-chloride calcium hypochlorite with deionised water having an electrical conductivity of 15-30 μScm-¹, and then acidifying the solution with phosphoric acid.

TABLE 4

| | Time (days) | | | | | | | | | | |
|---|---|---|---|---|---|---|---|---|---|---|---|
| | 0 | 7 | 12 | 20 | 27 | 35 | 47 | 57 | 71 | 86 | 96 |
| Cl₂ | 4000 | 4000 | 4000 | 4000 | 4000 | 4000 | 4000 | 3500 | 3250 | 2750 | 2750 |
| concentration | | | | | | | | | | | |
| (ppm) | | | | | | | | | | | |
| pH | 5.7 | 3.27 | 3.27 | 3 | 3.23 | 3 | 3.25 | 3.15 | 3.5 | 3.53 | 3.42 |

Whilst the stability of the solution of Example 4 is not as good as the stability of the solutions of Examples 1-3, Example 4 shows that it is possible to make an acidified chlorine solution having an improved shelf life by using calcium hypochlorite with a low chloride content of less than 3 wt %.

### Comparative Example

A solution of acidified chlorine was prepared using standard 68% calcium hypochlorite and deionised water. The pH and chlorine concentration was monitored over time.

TABLE 5

| | Time (months) | | | | | | |
|---|---|---|---|---|---|---|---|
| | 0 | 1 | 2 | 3 | 4 | 5 | 6 |
| Cl₂ concentration | 4000 | 3500 | 3250 | 2500 | 2250 | Test | Test |
| (ppm) | | | | | | ceased | ceased |
| pH | 5.2 | 3.34 | 3.24 | 3.25 | 3.20 | — | — |
| Oxidation- | | >1000 | | >1000 | | — | — |
| reduction | | | | | | | |
| potential (mV) | | | | | | | |

The results from the Examples and the Comparative Example illustrate how the solutions made by the method and apparatus of the present invention have improved properties over the standard, known process.

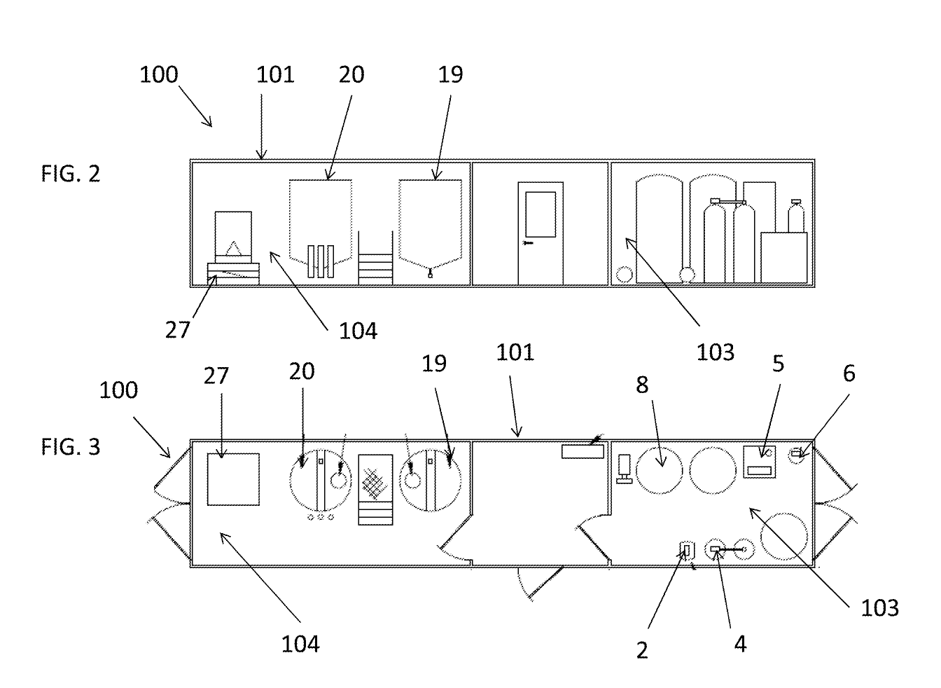

The apparatus of the present invention may be set-up close to a source of water, permitting treated water to be made where it is needed, thereby reducing transport costs. To facilitate transport and ease of movement of the equipment, the apparatus 1 of FIG. 1 may be incorporated into a shipping container 101 as shown in FIGS. 2 and 3 to provide a water treatment facility 100. The shipping container may be easily moved and transported, and provides a secure and low cost housing for the water treatment apparatus 1. Raw water is provided at inlet 2. The raw water is treated as described above using the water softener 4, the reverse osmosis unit 5 and the mixed bed ion exchange system 6. Water is stored in water storage container 8. The water inlet 2, the water softener 4, the reverse osmosis unit 5 and the mixed bed ion exchange system 6 and water storage container 8 are all located in a first part 103 of the container which is separate from a second part 104 of the container which contains the two reactors 19, 20 and the load cell 27.

Whilst the present invention has been described and illustrated with reference to particular embodiments, it will be appreciated by those of ordinary skill in the art that the invention lends itself to many different variations not specifically illustrated herein. By way of example only, certain possible variations will now be described.

The embodiment above describes the use of water with a high ion content, the water then being treated to remove ions. Alternatively, water having a very low ion content may be provided initially without the need for subsequent treatment to remove ions.

The embodiment described above describes the use of a water softener. The use of a water softener may not be essential if the input water is very soft. Alternatively, one or more scale inhibitor chemicals may be used to inhibit scale from forming.

The embodiment above describes the use of UV treatment of water to reduce the microbe content. Alternatively or additionally, it may be possible to use membranes to remove microbes from the water.

The embodiment above describes the use of reverse osmosis and mixed bed ion exchange resins to remove ions from water. Alternatively, water having a low ionic content may be produced by distillation and subsequent collection of the distilled water.

The embodiment above describes the use of two containers for the addition of the source of chlorine and the acid. In certain embodiments, one of those containers may be omitted. Alternatively, more than two such containers may be used.

The embodiment above describes the use of filters to remove precipitate. Alternatively or additionally, one or more centrifuges or cyclones may be used.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. A method of manufacturing an aqueous chlorine solution having a pH between 3.0 and 6.5 and a stability such that after 6 weeks storage at 20 degrees Celsius the pH remains in the range 3.0 to 6.5 and the amount of chlorine lost from the solution is less than 10%, the method comprising:
(a) Providing a source of water having an electrical conductivity of no more than 50 μScm⁻¹ at 20° C.;
(b) Reacting said water with solid calcium hypochlorite having a purity of at least 60%; and
(c) Adjusting the pH to between 3.0 and 6.5.

2. A method as claimed in claim 1 wherein the water provided in step (a) has an electrical conductivity at 20 degrees Celsius of no more than 4.3 μScm⁻¹, and the chlorine solution has a stability such that after 6 months storage at 20 degrees Celsius the pH remains in the range 3.0 to 6.5 and the amount of chlorine lost from the solution is less than 10%.

3. A method as claimed in claim 2, wherein the water is provided from an adjacent conductivity-reduction apparatus.

4. A method as claimed in claim 3 wherein the water is provided from an adjacent conductivity-reduction apparatus via an intermediate storage vessel.

5. A method as claimed in claim 4 comprising removing water from the storage vessel, treating said water to kill and/or remove microbes and reintroducing at least some of said water into the storage vessel.

6. A method as claimed in claim 5 wherein treating said water to kill and/or remove microbes comprises passing said water through a filter and/or exposing said water to electromagnetic radiation.

7. A method as claimed in claim 3, wherein the source of water having an electrical conductivity of less than 4.3 μScm-¹ is provided by a reverse osmosis apparatus and a mixed-bed ion exchange resin.

8. A method as claimed in claim 4, wherein the source of water having an electrical conductivity of less than 4.3 μScm-¹ is provided by a reverse osmosis apparatus and a mixed-bed ion exchange resin.

9. A method as claimed in claim 1, wherein the electrical conductivity at 20 degrees Celsius of the source of water is less than 2.5 μScm-¹.

10. A method according to claim 1 wherein the solid calcium hypochlorite is at least 75% pure.

11. A method according to claim 10 wherein the chloride contamination is below 1.0 wt % chloride.

12. An aqueous chlorine solution having a pH between 3.0 and 6.5 and a stability such that after 6 weeks storage at 20 degrees Celsius the pH remains in the range 3.0 to 6.5 and the amount of chlorine lost from the solution is less than 10%.

13. An aqueous chlorine solution according to claim 12 having a stability such that after 6 months storage at 20 degrees Celsius the pH remains in the range 3.0 to 6.5 and the amount of chlorine lost from the solution is less than 10%.

14. An aqueous chlorine solution according to claim 13 wherein the pH remains in the range 4.5 to 6.0.

15. An aqueous chlorine solution according to claim 13 wherein the amount of chlorine lost from the solution is less than 5%.

16. An apparatus for the chlorination of water, the apparatus comprising:
a) an apparatus for providing water having an electrical conductivity of 4.3 μScm-¹ or less at 20 degrees Celsius,
b) one or more reaction vessels for the production of an aqueous acidic chlorine solution being adapted to receive water from the apparatus for providing water and having at least one inlet for the introduction there through of solid calcium hypochlorite and a pH controlling agent,
c) one or more outlets for receiving the aqueous acidic chlorine solution from the one or more reaction vessels and for delivering aqueous acidic chlorine solution to a receptacle.

17. An apparatus according to claim 16 wherein one or more reaction vessels comprise chlorine-resistant reaction-mixture contacting surfaces.

18. An apparatus according to claim 17 wherein said surfaces are provided by a coating of chlorine-resistant material or by a reaction vessel shaped and/or constructed from chlorine-resistant material, the chlorine-resistant material being selected from one or more of polyvinyl chloride, polyvinylidene fluoride and polyethylene terephthalate.

19. A facility for the production of an aqueous acidic chlorine solution comprising an apparatus in accordance with claim 16 located within a shipping container.
